(19) United States
(12) Patent Application Publication
(10) Pub. No.: US 2023/0173604 A1
(43) Pub. Date: Jun. 8, 2023

(54) AUTOMATED FASTENER FEEDER AND SECURING SYSTEM

(71) Applicant: Doben Limited, Windsor (CA)

(72) Inventors: David M. Simone, Amherstburg (CA); Larry Koscielski, Lasalle (CA)

(21) Appl. No.: 18/074,728

(22) Filed: Dec. 5, 2022

Related U.S. Application Data
(60) Provisional application No. 63/285,740, filed on Dec. 3, 2021.

(51) Int. Cl. B23K 11/14; B23K 37/04

(52) U.S. Cl. CPC B23K 11/14; B23K 37/0435

(57) ABSTRACT

A method of securing a fastener to a workpiece includes a fastener that is loaded into a feeder, and an insertion head assembly that is provided adjacent to the feeder. The insertion head assembly includes an insertion actuator that has a movable insertion piston, and a clamp finger that is mounted to the insertion piston. The fastener is arranged beneath a movable fastener joining element that is carried by the insertion head assembly, the workpiece is positioned relative to a locating pin, the insertion head assembly is moved to engage the workpiece with the clamp finger, the fastener is brought into engagement with a locating pin, the fastener joining element is advanced relative to the clamp finger, and the fastener that is secured to the workpiece.

### CROSS-REFERENCE TO RELATED APPLICATIONS

The application claims priority to U.S. Provisional Application No. 63/285,740 filed Dec. 3, 2021, and is incorporated herein by reference.

### BACKGROUND

The disclosure relates to a fastener feeder for an automated fastener (nut, stud, etc.) securing system, which may employ welding or clinching, for example.

Fastener (stud or bolt) feeders for resistance welded and inserted clinch fasteners frequently employ a spear or pick-and-place motion to load the fastener (e.g., projection welded stud). The most common prior art feeders load the fastener into the movable fastener joining element (e.g., electrode) used for securing the fasteners to the workpiece (e.g., stamped sheet metal component). Typical means of transferring the fastener from the feeder to the fastener joining element include gravity, momentum, air, and or magnetic attraction. When using these fastener transfer techniques, contact is lost between the feeder and the fastener joining element, which can lead to misloaded fasteners.

One transfer technique has been developed, disclosed in U.S. Pat. No. 4,609,134 to Davern, in which the fastener is transferred to a tube with a split in the end. An anvil pushes the fastener through the split in the tube during the riveting operation. The design of Davern' s system is not suitable for fastener clinching and/or welding operations, since it is not particularly robust or consistently repeatable.

### SUMMARY

In one exemplary embodiment, a method of securing a fastener to a workpiece includes a fastener that is loaded into a feeder, and an insertion head assembly that is provided adjacent to the feeder. The insertion head assembly includes an insertion actuator that has a movable insertion piston, and a clamp finger that is mounted to the insertion piston. The method includes the fastener that is arranged beneath a movable fastener joining element that is carried by the insertion head assembly, the workpiece that is positioned relative to a locating pin, the insertion head assembly that is moved to engage the workpiece with the clamp finger, the fastener that is brought into engagement with a locating pin, the fastener joining element that is advanced relative to the clamp finger, and the fastener that is secured to the workpiece.

In a further embodiment of any of the above, the arranging step includes pushing the fastener into opposing insertion jaws that are arranged beneath the movable fastener joining element, and the advancing step includes pushing the fastener past and separating the insertion jaws.

In a further embodiment of any of the above, the fastener is pushed past the insertion jaws by deflecting flat spring steel jaw springs that support the insertion jaws relative to the insertion piston.

In a further embodiment of any of the above, the advancing step is performed prior to the bringing step.

In a further embodiment of any of the above, the bringing step includes displacing the locating pin with the fastener to insert a threaded element into a hole in the workpiece.

In a further embodiment of any of the above, the securing step includes welding the fastener to the workpiece.

In a further embodiment of any of the above, the moving step includes moving the insertion piston and the fastener joining element coaxially with one another.

In a further embodiment of any of the above, the moving step is performed with an actuator.

In a further embodiment of any of the above, the moving step includes moving the insertion head assembly in unison with the fastener joining element.

In a further embodiment of any of the above, the advancing step occurs when, in performance of the moving step, continued engagement of the workpiece with the clamp finger forces the insertion piston into the insertion actuator.

In another exemplary embodiment, a fastener securing system includes a feeder that is configured to receive a fastener. A fastener securing gun has an insertion head assembly that is adjacent to the feeder. The insertion head assembly includes an insertion actuator that has a movable insertion piston, and a clamp finger is mounted to the insertion piston. A movable fastener joining element is carried by the insertion head assembly. A stationary element is opposite the fastener joining element and is configured to support a workpiece. A gun actuator is configured to move the insertion head and the fastener is loaded on the fastener joining element in unison with one another from a retracted position toward the workpiece to an advanced position in which the clamp finger engages the workpiece. The gun actuator is configured to continue to move the fastener joining element and its loaded fastener to an overrun position in which the fastener joining element moves relative to the finger clamp to secure the fastener to the workpiece.

In a further embodiment of any of the above, the insertion head assembly includes opposing insertion jaws that are supported relative to the insertion piston by springs. The insertion jaws are configured to receive the fastener in a gap. The fastener joining element is configured to push the fastener past the insertion jaws and onto the workpiece.

In a further embodiment of any of the above, the springs are constructed from flat spring steel.

In a further embodiment of any of the above, the clamp finger has a textured tip that is configured to engage the workpiece in the advanced position.

In a further embodiment of any of the above, the stationary element includes a support face that circumscribes a movable locating pin. The fastener is spaced from the locating pin upon an initial contact of the finger clamp with the workpiece in the advanced position. The fastener joining element depresses the locating pin via the fastener when moving from the advanced position to the overrun position.

In a further embodiment of any of the above, the fastener joining element and the stationary element are welding electrodes.

In a further embodiment of any of the above, the insertion actuator is an air cylinder with at least a portion of the insertion piston that is arranged therein, and an air pressure within the air cylinder that is configured to provide a clamping force to the workpiece via the clamp finger.

### BRIEF DESCRIPTION OF THE DRAWINGS

The disclosure can be further understood by reference to the following detailed description when considered in connection with the accompanying drawings wherein:

FIG. 1 is schematically illustrates a fastener securing cell.

FIG. 2 is a perspective view of a fastener welding station.

FIG. 3 is a perspective view of an example fastener feeder according to this disclosure.

FIG. 4 is a cross-sectional view of the feeder shown in FIG. 3 with a fastener entering the feeder.

FIG. 5 is a cross-sectional view of the feeder shown in FIG. 3 with the fastener positioned adjacent to a push rod.

FIGS. 6A and 6B depict push rod advanced (gun fastener loading position) and retracted positions.

FIG. 7A-7D illustrate various positions during fastener securing to a workpiece, including end and top views of the insertion jaws without a fastener present for clarity.

FIG. 8A-8F are cross-sectional views through the jaws depicting the fastener during various positions during fastener securing.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

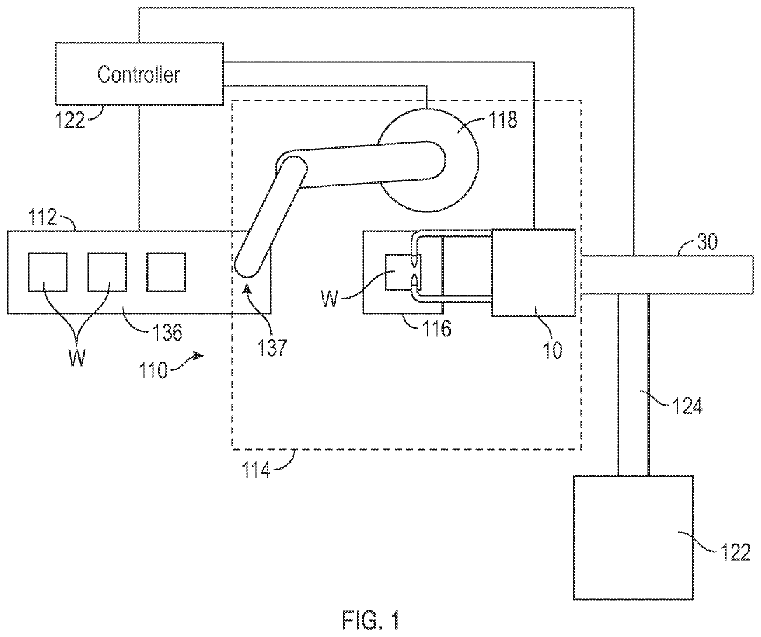

A welding cell 110 is illustrated in FIG. 1. The cell 110 includes a conveyor 112 that feeds workpieces W along a static bed 136 along a workpiece flow path to a work area, which includes a robot 118 and a fastener securing system 10, such as a weld gun, for example. A robot 118 picks up the workpiece W from an unloading position 137 on the conveyor 112 and carries it to a fixture 116 where the fastener securing system 10 performs various securing operations (e.g., welding or clinching). A controller 122 may be connected to the conveyor 112, robot 118 and fastener securing system 10 to coordinate their operation for efficiency.

The conveyor 112 pulls or pushes workpieces W along a surface or workpiece support portion of a static bed 136 in such a fashion as to manipulate the workpieces W from a crude load position to a predictable unload position.

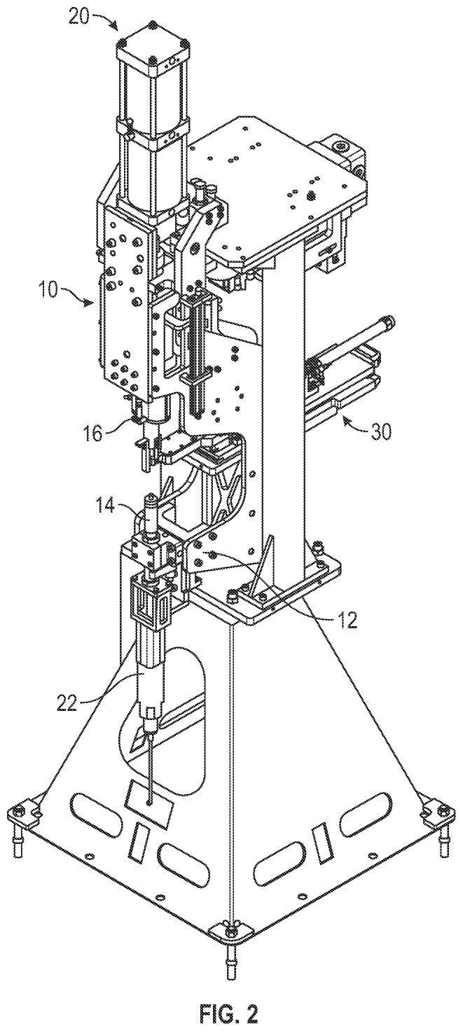

FIG. 2 shows a fastener securing system 10 suspended by a frame that is mounted on a pedestal. The attitude of the fastener securing system 10 and the configuration of the equipment is not relevant and may be varied from the arrangement shown. The fastener securing system 10 could be mounted to a robot, for example, to manipulate and position it with respect to the workpiece 24. Workpiece 24 could for example be an assembly or subassembly of an automobile requiring several different orientations and positions. While the illustrations show a resistance welding gun, the principles apply to press systems which install clinch fasteners in a pre-placed hole in the workpiece.

The term “stationary” has been used to indicate that the referenced stationary arm 12 or stationary electrode assembly 14 is not the actively moving element of the fastener securing system 10. This is common terminology associated with the process. A robot, as noted above, or other apparatus (SoftMount™) could enable the fastener securing system 10, and thereby the stationary electrode assembly 14, to move relative to the workpiece 24 or machine. While the term “electrode” is used for simplicity in reference to the example illustrated resistance welding gun, it should be understood that the term “ram” and/or “die” could be used in the case of a clinching operation. Thus, the term “electrode” or similar terms should not be construed as limiting.

The fastener securing system 10 receives a fastener (e.g., a projection weld or clinch stud) dispensed one at a time from a bulk source, such as a vibratory bowl feeder. The system 10 then inserts the fastener into the workpiece hole provided to receive and properly locate it before the assembly operation is performed. The configuration is applicable to resistance welding of projection studs (shown in the illustrations), the pressing of clinch studs, unthreaded studs, similar components such as spacers, and other fasteners such as resistance welded and clinch nuts.

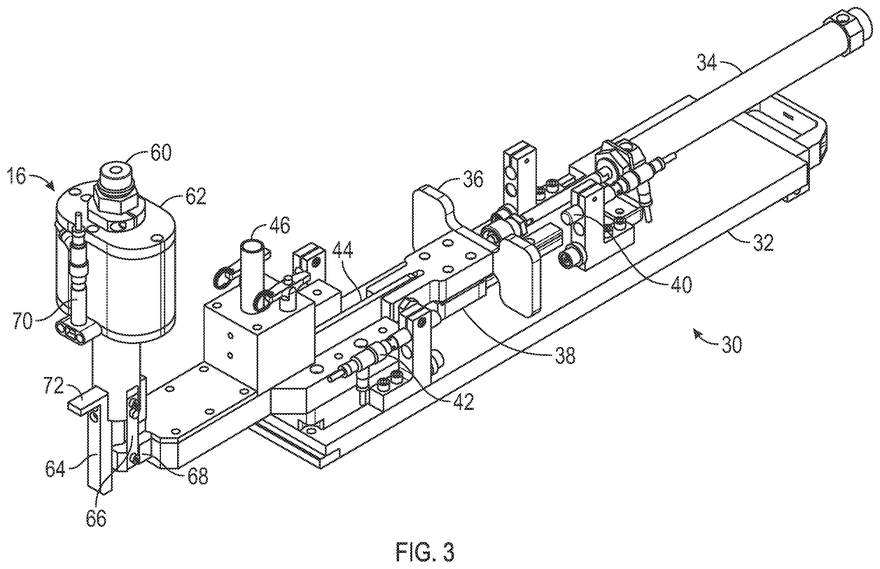

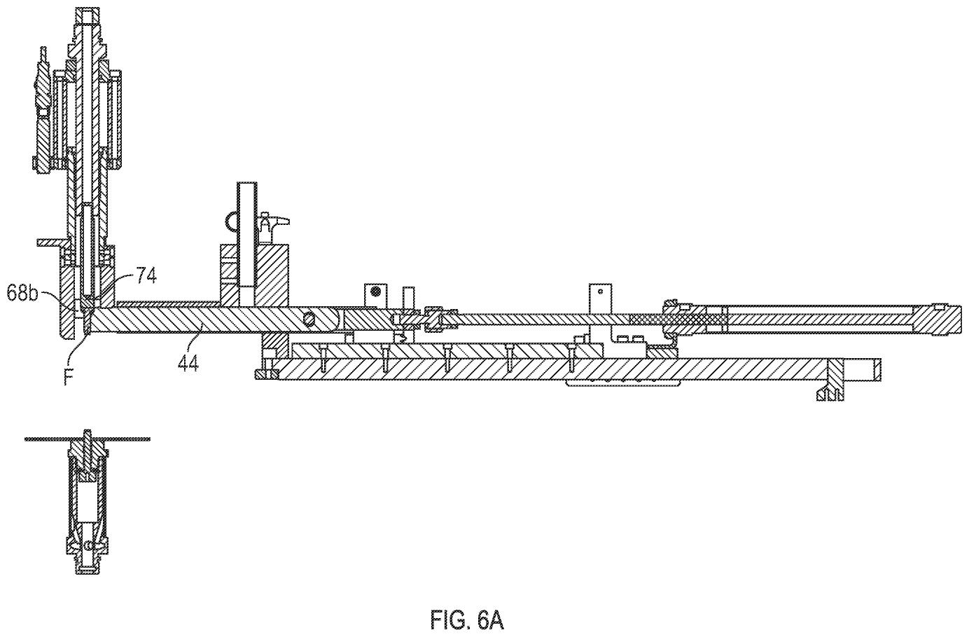

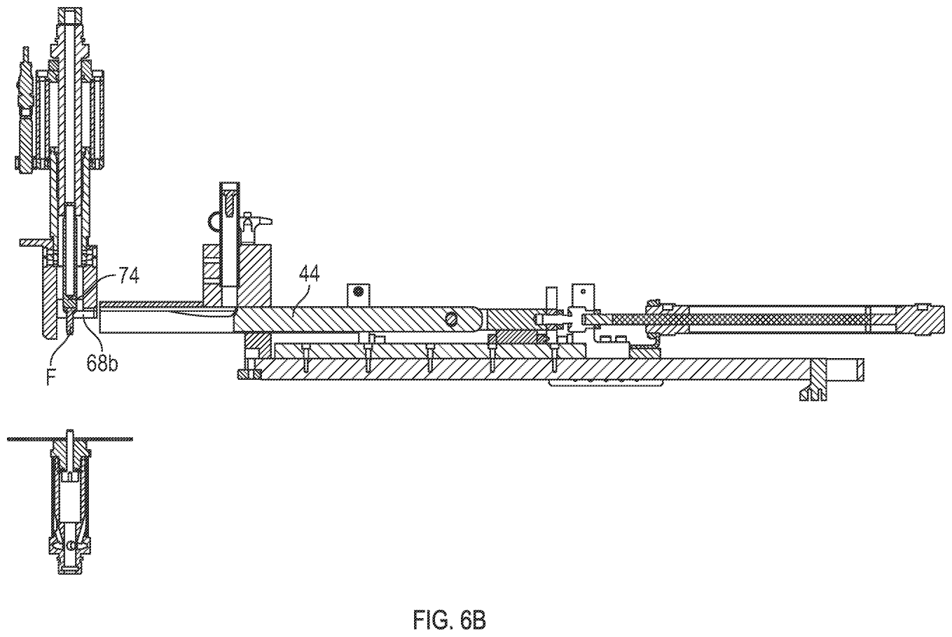

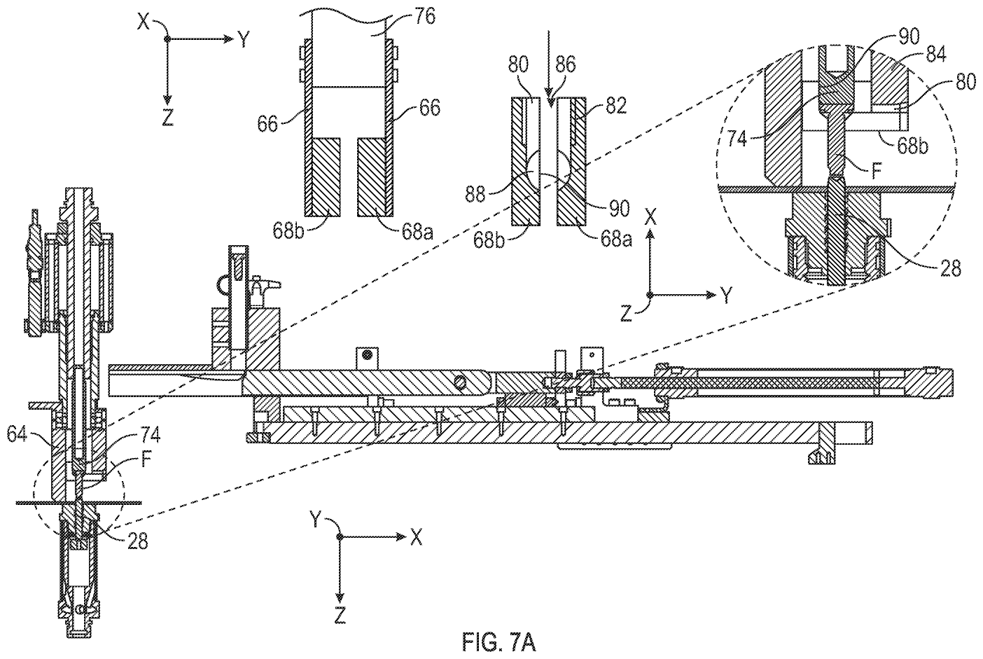

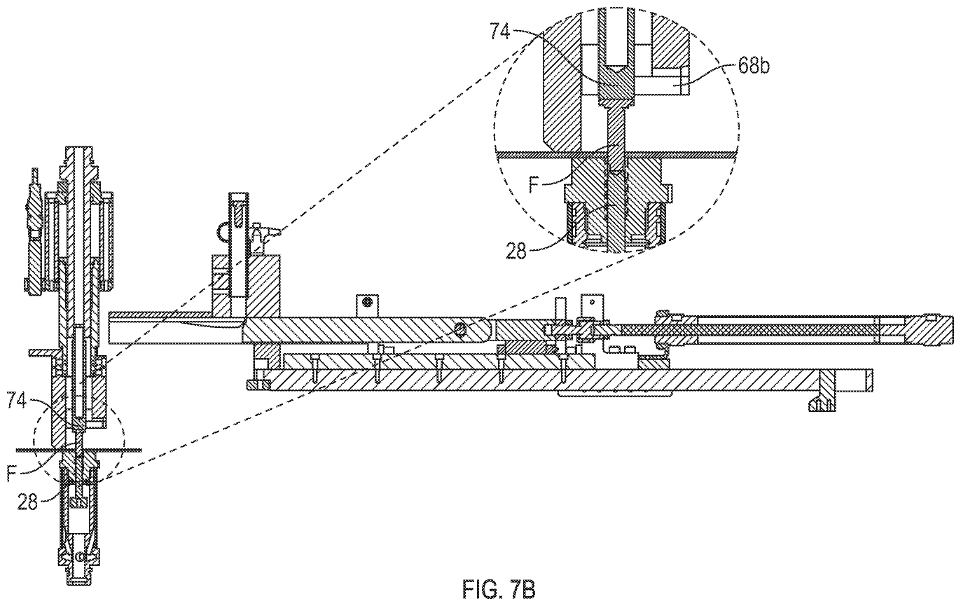

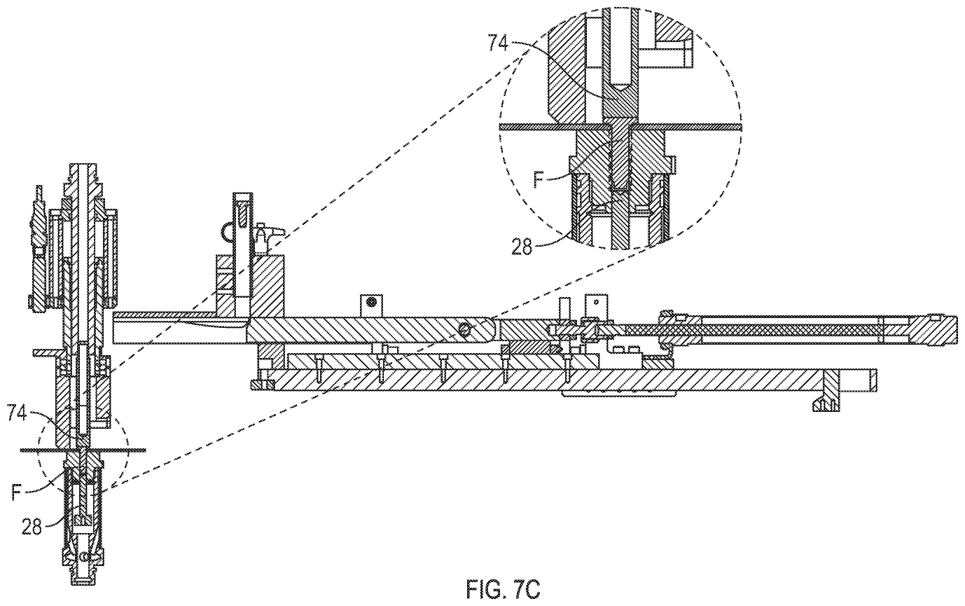

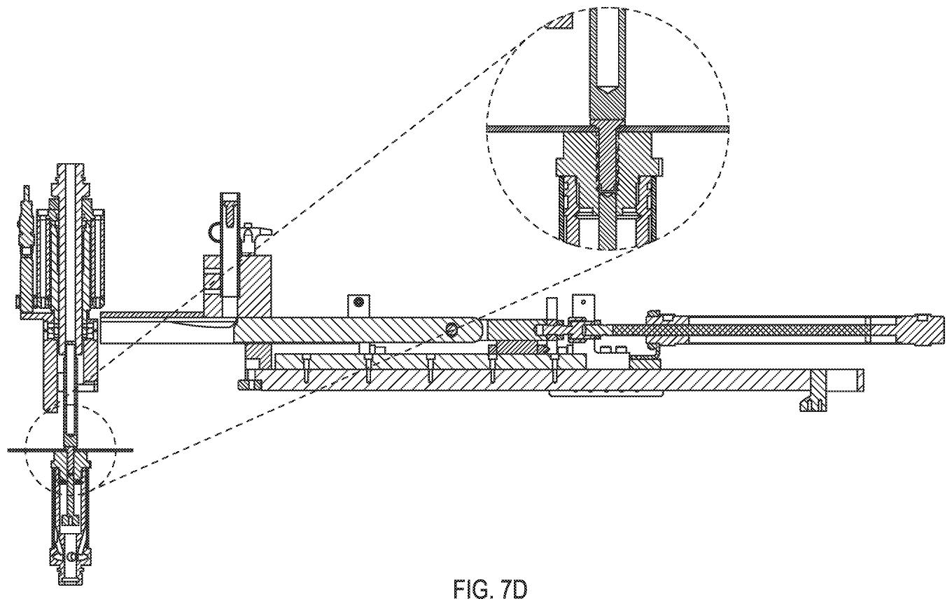

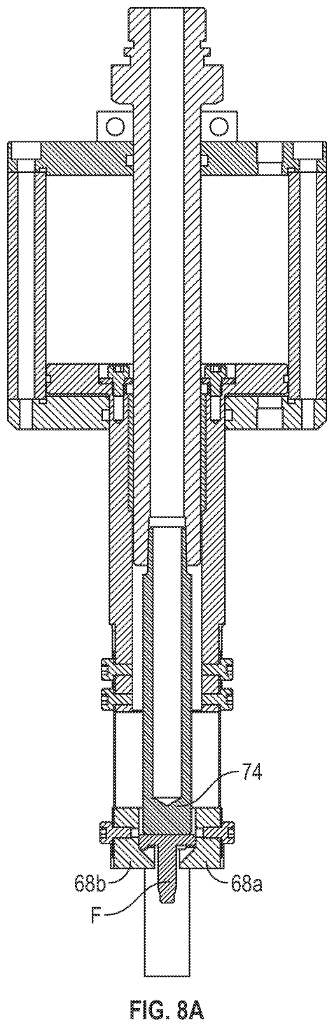

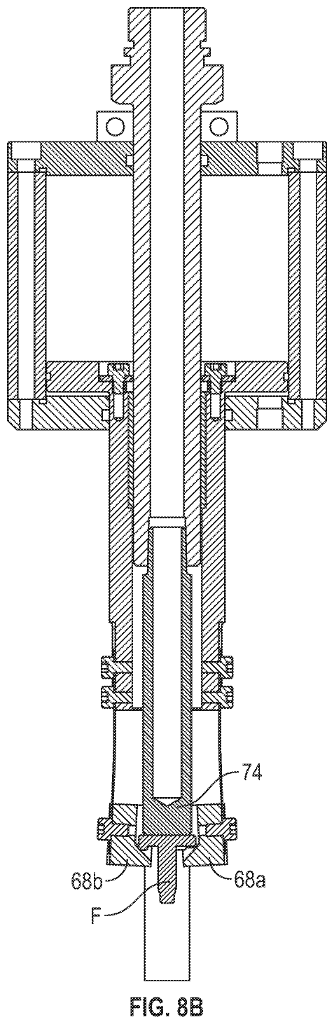

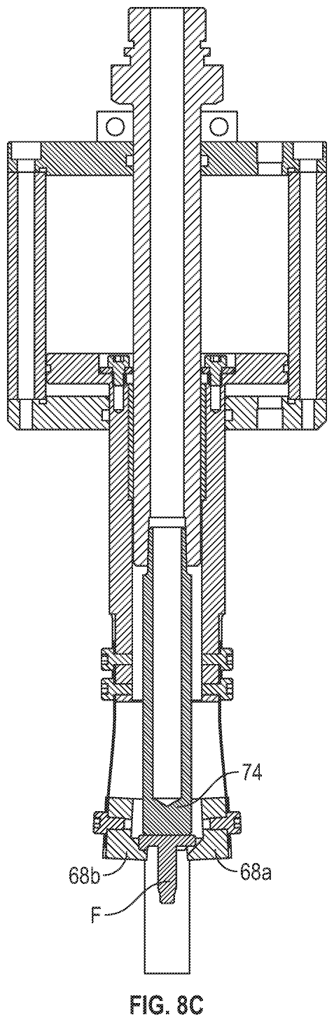

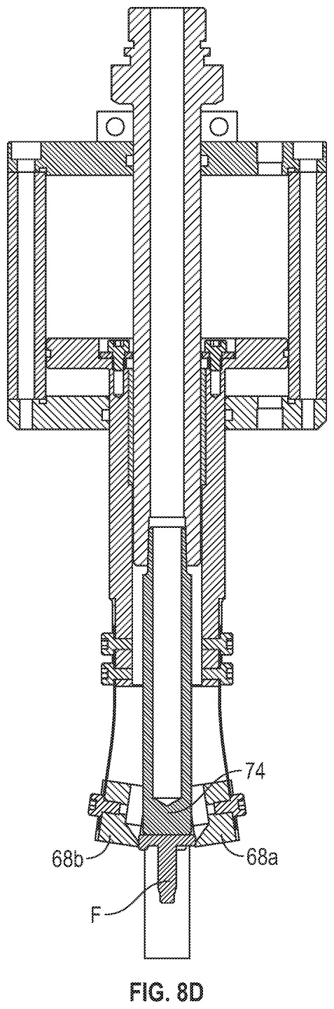

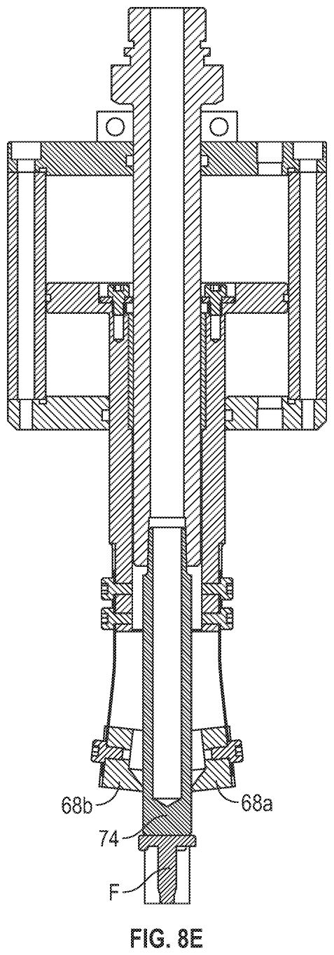

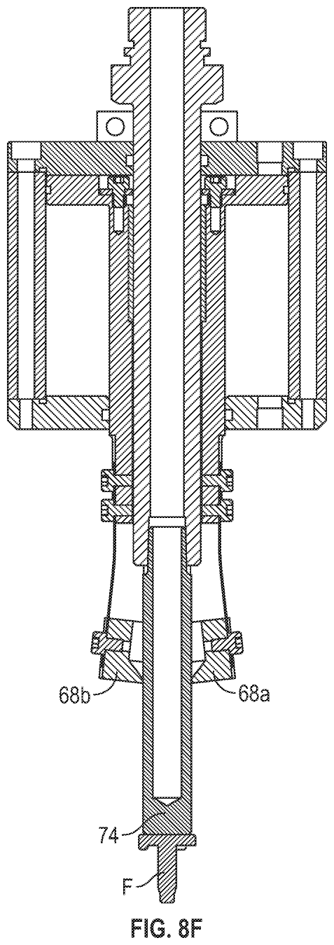

FIG. 3 shows an isometric view of the fastener insertion head assembly 16 and fastener feeder assembly 30. The feeder assembly 30 has a quick-change adapter 32 that orients and facilitates replacement all of the feed assembly components so the fastener securing system can be converted to secure a different fastener through the simple substitution of another quick-change adapter. An insertion actuator 62, which provides a clamping force while securing the fastener to the workpiece, has an elongated shape that prevents rotation of an insertion piston 76. The insertion piston 76 includes an end that engages the fastener during the joining operation (see, FIGS. 6A-7D). A gun actuator 20 advances and retracts the insertion head assembly 16 to engage the workpiece with the fastener via the insertion piston 76. A more conventional round piston and a different manner of limiting rotation of the insertion piston is also possible. The gun actuator 20 and insertion actuator 62 are shown as pneumatic cylinders but, one or both could be electrically operated.

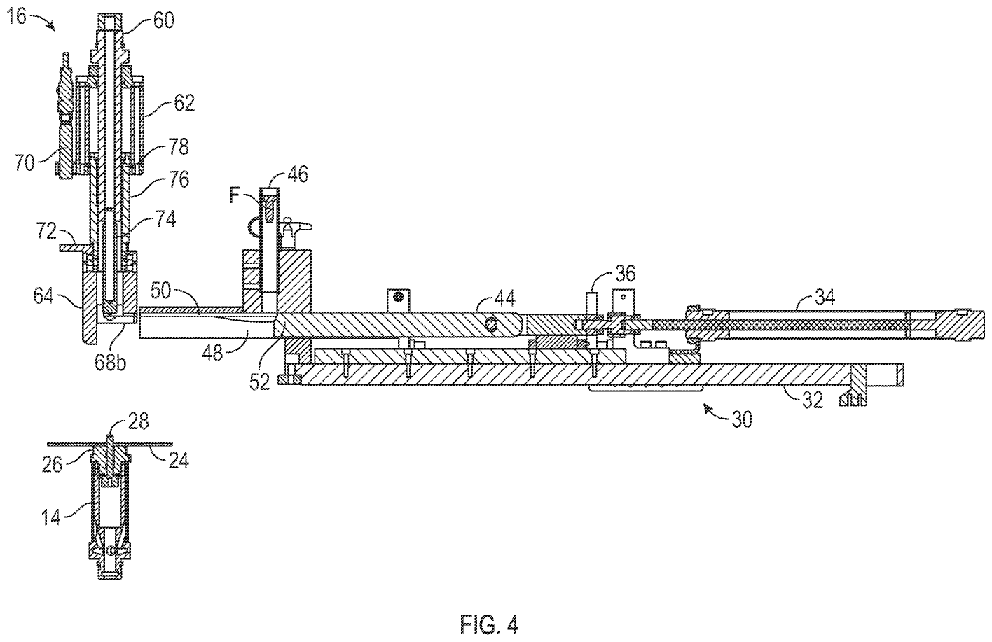

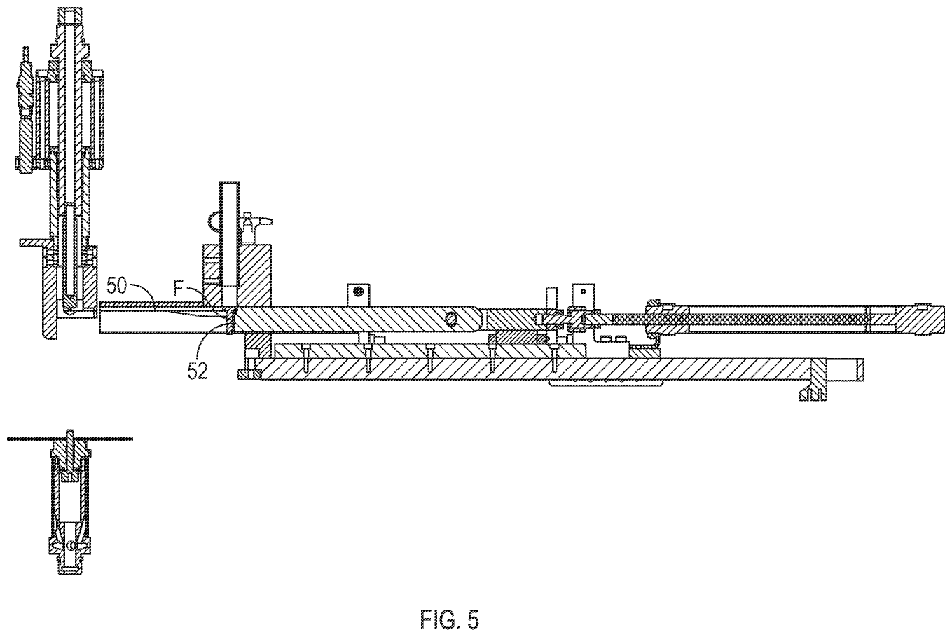

With reference to FIGS. 4 and 5, a fastener joining element 74 (e.g. electrode), is rigidly attached to the gun actuator 20. In the example, the insertion actuator 62 is fixed relative to and carried by the fastener joining element 74, which may be constructed from multiple pieces. The insertion piston 76 is coaxial with the fastener joining element 74 in the example, although other arrangements may be used. A clamp finger 64 is mounted to the insertion piston 76.

The gun actuator 20 is configured to move the insertion head 62 and the fastener loaded on the fastener joining element 74 in unison with one another from a retracted position (FIGS. 6A-6B) toward the workpiece to an advanced position (FIG. 7A) in which the clamp finger 64 engages the workpiece. The gun actuator 20 configured to continue to move the fastener joining element 74 and its loaded fastener to an overrun position in which the fastener joining element 74 moves relative to the clamp finger 64 to secure the fastener to the workpiece. The fastener joining element 74 depresses a workpiece locating pin 28 via the fastener when moving from the advanced position to the overrun position.

While FIG. 3 shows the fastener feeder assembly 30 in a fixed position relative to the fastener insertion head assembly 16, one or both of these system components could be moveable. An example may be to tip the fastener insertion head assembly 16 so the moveable electrode 74 is not axially aligned with the stationary electrode 26 during fastener F loading. This could be necessary to provide for improved workpiece loading, may be done to eliminate the possibility of a pinch point (between the electrodes) during manual workpiece loading, or may just change the resistance welding gun 10 configuration to facilitate workpiece access.

In FIG. 4, the electrode adapter 60 and moveable electrode 74 are conventional copper components used for resistance welding. The insertion piston 76 includes a sleeve bushing 78 to cooperate with the outside of the electrode adapter 60 and ensure axial alignment. The clamp finger 64 and left- and right-hand insertion jaws 68a, 68b are preferably made from hardened steel to resist deformation and wear. The length of the clamp finger 64 is preferably determined so the fastener F is not depressing the workpiece locating pin 28 when the clamp finger 64 clamps the workpiece F to the stationary electrode 26. The gap ensures the workpiece locating pin 28 is not prematurely dislodged from the workpiece 24. And that the motion that pushes the locating pin 28 from the workpiece 24 is concurrent with the insertion of the fastener F. The gap is application specific but, in most cases, 3 mm between the fastener F and locating pin 28 is sufficient to provide for fastener length variation and wear or subsequent redressing of the stationary electrode 26.

While not illustrated, the tip of clamp finger 64 can be textured (e.g., knurled, or fit with pointed pins that would engage the surface of the workpiece 24) to prevent slippage. This may be particularly useful if the clamp force needs to be kept low if, for example, the workpiece is easily deformed.

When the resistance welding gun 10 is at rest, actuator 20 will be retracted to maximize the distance between the electrodes of the fastener insertion head assembly 16 and stationary electrode assembly 14. This electrode spacing ensures a maximum clear opening while the workpiece 24 or welding gun 10 is manually or automatically positioned to engage the workpiece locating pin 28 in the hole in workpiece 24 that is to receive the fastener F. During this operation, the insertion piston 76 would typically be advanced to hold a fastener F adjacent to the moveable electrode. If it is advantageous for workpiece manipulation or the operating cycle, insertion piston 76 can be retracted while positioning the workpiece on the locating pin 28.

To load a fastener F in preparation for welding, the actuator 20 remains returned while the insertion piston 76 is advanced. This positions the insertion jaws 68 in line with the feeder discharge 48. The returned position of feeder ram 36 is confirmed by the feeder returned switch 40. With the feeder push rod 44 clear of the fastener feed tube 46 a fastener F, can be supplied to the fastener feeder assembly 30. To transfer the fastener F from the feeder assembly 30 to the fastener insertion head assembly 16 the fastener feed actuator 34 drives the feeder push rod 44. The push rod 44 urges the fastener F through the feeder discharge 48 and into the fastener insertion jaws 68. The push rod face 52 and fastener head guide channels 50 cooperate with the fastener F maintain alignment, thus ensuring smooth and efficient transit. Once the feeder advanced switch is operated to confirm the fastener F placement, the feed actuator 34 is returned to its home position.

With a fastener F positioned in front of the moveable electrode 74 of the fastener insertion head assembly 16 and the workpiece 24 located by the workpiece locating pin 28 the fastener insertion process can be executed. When the feeder ram 36 is actuating the feeder returned switch 40, the machine control can permit operation of the actuator 20 to advance the fastener insertion head assembly 16. The motion proceeds until clamp finger 64 contacts workpiece 24 and presses it against the stationary electrode 26. The fastener F will then engage the end of workpiece locating pin 28. The workpiece locating pin 28 has a concave shape on the end to center the stud, and a larger diameter than the Fastener F to ensure there is clearance between the fastener thread and the hole in the workpiece 24. Actuator 20 will overcome the force applied by the fastener insertion head assembly 16 and will push the insertion piston 76 into the insertion actuator 62. The air pressure supplied to the insertion piston 76 determines the clamping force applied by the clamp finger 64 used to secure the workpiece 24 against the stationary electrode 26. The fastener F and moveable electrode 74 pushes against the insertion jaws 68, causing the insertion jaw springs 66 (e.g., flat spring steel) to deflect so the insertion jaws 68 release the fastener F. Fastener F, urged by actuator 20, pushes against the workpiece locating pin 26 into the stationary electrode assembly. The force on the workpiece locating pin 26 is determined by the fastener locating pin drive unit 22, which may also include provisions for sensing fastener and operation characteristics (e.g., fastener length, insertion speed, welding upset distance).

The actuator 20 will not advance and the weld sequence is inhibited whenever the feeder ram 36 and clamp finger 64 are not returned. The returned position of feeder ram 36 is confirmed by actuation of the feeder returned switch 40. The returned position of the clamp finger 64 is confirmed when the clamp finger target 72 actuates the insertion head retracted switch 70.

With the fastener F insertion confirmed by the position of the fastener insertion head assembly 16 and/or workpiece locating pin 28, the insertion piston 76 can be retracted to withdraw the claim finger 64. Since the fastener F will be held in position by contact with the moveable electrode 74, retraction of the insertion piston will cause the fastener insertion jaws 68 push against the insertion jaw springs 66 and pull away from the fastener F. Motion will continue until the insertion apparatus is clear of the welding operation. When the clamp finger target 72 engages the insertion head retracted switch 70, the home position of the insertion apparatus is confirmed to permit the welding sequence start. At the end of the weld time, the actuator 20 is retracted to return the fastener insertion head assembly 16. The workpiece locating pin drive unit 22 may or may not be advanced to extend the workpiece locating pin 28 to press against the fastener F to assist in freeing the fastener and weldment from the stationary electrode.

The insertion jaws 68 include insertion channels 80 aligned with the guide channels 50 to receive the fastener F as the push rod 44 pushes it beneath the fastening element (e.g., moveable electrode) 74 to a conical recess 88 adjoining a stop 90. A block 84 is seated between notches 82 in the insertion jaws 68 to maintain a gap 86. When the moveable electrode 74 advances, the fastener forces the insertion jaws 68 apart, during which the springs 66 flex.

The feed assembly, which receives the fasteners one at a time when other process functions are being performed and transfers the fastener into the fastener insertion head assembly. An independent fastener inspection function can easily be added in the feed assembly to verify attributes of the fastener such as length or thread presence. The fastener insertion head assembly includes spring-loaded movable fastener positioning jaws to hold the fastener in the correct position and alignment with the electrode or die. An electrode or die with a movable pin provided to locate the hole in the workpiece that will receive the fastener. A clamp finger pushes (secures) the workpiece against the electrode or die to maintain the workpiece alignment as the fastener displaces the workpiece locating pin. A cylinder that retracts the fastener positioning jaws and clamp finger, so they are distant, and protected, from the assembly (i.e., welding) process. When the positioning jaws are retracted, the welding electrode is easily accessible for maintenance—sometimes to clean is but generally to replace it.

The apparatus enables the fastener to be loaded into the application tooling (resistance welding electrode or clinch die) when the workpiece is being loaded or unloaded. This minimizes cycle time and improves operation safety. No cycle time is necessary to place the fastener in position for welding or pressing since the insertion into the tooling occurs parallel to loading or unloading of the workpiece. The action to place the fastener into the electrode assembly or clinch tooling occurs out of sight without moving apparatus that might pose a hazard to an operator or automation. An example of a hazard is unintended impact with a conventional high-speed pick-and-place or spear-type feed mechanisms.

There is continuous positive engagement with the fastener, so the system does not rely on gravity, momentum, or magnetic attraction to ensure the fastener is retained and properly oriented. This enables the feeding system to function in any orientation or a variety of orientations for robotic installations.

The fastener is loaded into the workpiece without risk of fastener thread or workpiece hole damage due to misalignment between the fastener and workpiece hole during insertion. Abrasion or deformation of the fastener threads can make subsequent assembly difficult. Abrasion or deformation of the workpiece hole can result in an improperly located fastener.

When used in conjunction with the CenterLine VeriFast™ system (U.S. Pat. Nos. 6,576,859, 6,906,279 and 7,282,664) the stud length can be verified at the time of insertion, and prior to the assembly process. The assembly process can be verified using the method of U.S. Pat. No. 7,564,005. Changeover from one fastener to another requires minimal adjustments and tuning. The above references are incorporated herein by reference in their entirety.

The fastener can be loaded into or against the welding electrode or clinching die while the workpiece is being loaded or manipulated—resulting in substantially improved productivity. The fastener is physically retained at all times, unlike feeding approaches that use inertia, gravity, magnets, vacuum pressure and other supplementary approaches for retention. The fastener can be loaded with the welding unit in any orientation or a number of orientations for robotic applications. There is no possibility that the electrodes can close on and be damaged by a misaligned fastener. The fastener loading system does not pose a pinch, or impact hazard. The fastener loading system does not add to the width of the welding gun and it can load through the welding gun so there is no additional consideration of hardware in proximity to the workpiece. This makes planning for tooling and workpiece manipulation a lot easier.

The fastener loading system is integrated with the welding gun so the welding gun can be moved relative to the workpiece to enable the workpiece locating pin to center in the workpiece hole that will receive the fastener (the CenterLine SoftMount™ Gun). The feed mechanism is more robust because it does not involve long dynamic cantilevered loads. Most importantly, the clamp finger maintains the workpiece position throughout the fastener insertion cycle so the fastener remains centered in the workpiece hole and the fastener thread cannot be raked against the workpiece hole.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. A method of securing a fastener to a workpiece, comprising:
loading a fastener into a feeder;
providing an insertion head assembly adjacent to the feeder, the insertion head assembly including an insertion actuator having a movable insertion piston, and a clamp finger is mounted to the insertion piston;
arranging the fastener beneath a movable fastener joining element carried by the insertion head assembly;
positioning the workpiece relative to a locating pin;
moving the insertion head assembly to engage the workpiece with the clamp finger;
bringing the fastener into engagement with a locating pin;
advancing the fastener joining element relative to the clamp finger; and
securing the fastener to the workpiece.

2. The method of claim 1, wherein the arranging step includes pushing the fastener into opposing insertion jaws arranged beneath the movable fastener joining element, and wherein the advancing step includes pushing the fastener past and separating the insertion jaws.

3. The method of claim 2, wherein the fastener is pushed past the insertion jaws by deflecting flat spring steel jaw springs that support the insertion jaws relative to the insertion piston.

4. The method of claim 1, wherein the advancing step is performed prior to the bringing step.

5. The method of claim 1, wherein the bringing step includes displacing the locating pin with the fastener to insert a threaded element into a hole in the workpiece.

6. The method of claim 4, wherein the securing step includes welding the fastener to the workpiece.

7. The method of claim 1, wherein the moving step includes moving the insertion piston and the fastener joining element coaxially with one another.

8. The method of claim 1, wherein the moving step is performed with an actuator.

9. The method of claim 7, wherein the moving step includes moving the insertion head assembly in unison with the fastener joining element.

10. The method of claim 8, wherein the advancing step occurs when, in performance of the moving step, continued engagement of the workpiece with the clamp finger forces the insertion piston into the insertion actuator.

11. A fastener securing system comprising:
a feeder configured to receive a fastener;
a fastener securing gun having an insertion head assembly adjacent to the feeder, the insertion head assembly including an insertion actuator having a movable insertion piston, and a clamp finger is mounted to the insertion piston, a movable fastener joining element carried by the insertion head assembly;
a stationary element opposite the fastener joining element and configured to support a workpiece;
a gun actuator configured to move the insertion head and the fastener loaded on the fastener joining element in unison with one another from a retracted position toward the workpiece to an advanced position in which the clamp finger engages the workpiece, the gun actuator configured to continue to move the fastener joining element and its loaded fastener to an overrun position in which the fastener joining element moves relative to the finger clamp to secure the fastener to the workpiece.

12. The system of claim 11, wherein the insertion head assembly includes opposing insertion jaws supported relative to the insertion piston by springs, the insertion jaws configured to receive the fastener in a gap, wherein the fastener joining element is configured to push the fastener past the insertions jaws and onto the workpiece.

13. The system of claim 12, wherein the springs are constructed from flat spring steel.

14. The system of claim 11, wherein the clamp finger has a textured tip configure to engage the workpiece in the advanced position.

15. The system of claim 11, wherein the stationary element includes a support face circumscribing a movable locating pin, the fastener spaced from the locating pin upon an initial contact of the finger clamp with the workpiece in the advanced position, and the fastener joining element depressing the locating pin via the fastener when moving from the advanced position to the overrun position.

16. The system of claim 11, wherein the fastener joining element and the stationary element are welding electrodes.

17. The system of claim 11, wherein the insertion actuator is an air cylinder with at least a portion of the insertion piston arranged therein, and an air pressure within the air cylinder config to provide a clamping force to the workpiece via the clamp finger.
